(19) United States
(12) Patent Application Publication
(10) Pub. No.: US 2020/0319701 A1
(43) Pub. Date: Oct. 8, 2020

(54) WEARABLE DEVICE

(71) Applicant: ZTE CORPORATION, Shenzhen, Guangdong (CN)

(72) Inventors: Ting LIU, Shenzhen, Guangdong (CN); Yinchuan SUN, Shenzhen, Guangdong (CN); Yanxin CHEN, Shenzhen, Guangdong (CN)

(21) Appl. No.: 16/305,084

(22) PCT Filed: Nov. 18, 2016
(86) PCT No.: PCT/CN2016/106364

§ 371 Date: Nov. 28, 2018

(30) Foreign Application Priority Data
May 31, 2016 (CN) 201610379316.5

(51) Int. Cl. G06F 3/01; G06F 1/16

(52) U.S. Cl. CPC G06F 3/011; G06F 1/163

(57) ABSTRACT

Disclosed is a wearable device (10), comprising a screen (102) and a PCB plate (104). The PCB plate (104) is provided with a predetermined key (106) for executing a predetermined function. The screen (102) is provided right above the PCB plate (104). The screen (102) is used for receiving external pressure on the wearable device (10), wherein same is applied to the predetermined key (106) to enable the predetermined key (106) to execute the predetermined function.

### CROSS-REFERENCE TO RELATED APPLICATION

This is a National Phase application filed under 35 U.S.C. 371 as a national stage of PCT/CN2016/106364, filed Nov. 18, 2016, an application claiming the benefit of Chinese Application No. 201610379316.5, filed May 31, 2016, the contents of which is hereby incorporated by reference in its entirety.

### FIELD OF THE INVENTION

The present disclosure relates to communication technologies, and in particular to a wearable device.

### BACKGROUND

Currently, keys (for performing predetermined functions) of commercial wearable devices (such as smart watches, and smart bracelets) on the market are arranged at two locations, i.e., the front surface of the device and the side surface of the device. Taking a power key for starting a device and a volume adjustment key for adjusting volume as an example, the key arrangement on the front surface of the device occupies a large display area of the device, resulting in an unattractive appearance. The keys are arranged on the side surface of the device in two ways. In one way, a knob-type key (similar to the key used in a mechanical watch) can be employed, which is pressed for a long period of time to turn on the device and is rotated to adjust the volume. However, the knob-type key is small such that the operation is very inconvenient. In the other way, the power key is arranged on one side and the adjustment key is arranged on the other side. There are also some devices that use the keys in combined ways. For example, the power key is arranged on the front surface while the two adjustment keys are arranged on the side surface. For the key arrangements of above-mentioned wearable devices, since the keys are usually formed small, it is difficult for a user having large hands to accurately press when the wearable device is worn. Especially in an outdoor environment, it often takes time to stare at the equipment to make careful operations.

Therefore, the key arrangements of above-mentioned wearable devices have the problems that the key arrangements affect the device display and the operability is inferior, resulting in lowered user experience.

### SUMMARY

Embodiments of the present disclosure provide a wearable device to at least solve at least one of the above problems of the key arrangements of above-mentioned wearable devices in the related art.

According to an embodiment of the present disclosure, there is provided a wearable device comprising a screen and a printed circuit board PCB provided with a predetermined key for executing a predetermined function, the screen being provided directly above the PCB, wherein the screen is configured to receive external pressure on the wearable device, and the pressure is applied to the predetermined key to enable the predetermined key to perform the predetermined function.

Optionally, in a case where at least two predetermined keys are provided, a distance between the at least two predetermined keys is greater than a predetermined distance.

Optionally, an identification point is provided on the screen at a position corresponding to the predetermined key, and is configured to identify a relative position of the predetermined key on the screen.

Optionally, a protruding member is provided directly below the screen at a position corresponding to the predetermined key, and is configured to increase an easiness of pressing the predetermined key against the screen.

Optionally, a resilient support member is disposed between the PCB and the screen.

Optionally, the resilient support member is a spring or an elastic plastic.

Optionally, in a case where at least two predetermined keys are provided, the resilient support member is disposed between the at least two predetermined keys.

Optionally, an upper casing and a lower casing are provided, wherein the upper casing is fixedly mounted to the screen, the PCB is disposed between the screen and the lower casing, and the upper casing and the screen are coupled by snap-on connection.

Optionally, the predetermined key is a power key and/or an adjustment key.

Optionally, the wearable device is a smart watch or a smart bracelet.

Through the embodiments of the present disclosure, the function key for executing the predetermined function is disposed on the Printed Circuit Board (PCB), and applies the external pressure received through the screen to the predetermined key to perform the predetermined function. Since the predetermined key is hidden inside the wearable device, it is invisible from the outside of the device. In the meanwhile, it is easy to complete the design of structural components of the actual wearable device, and the predetermined functions such as booting and volume adjustment can be realized. Therefore, the problems that the arrangements of the keys of the wearable devices affect the device display and the operability is inferior in the related art can be solved, thereby improving the user experience.

### BRIEF DESCRIPTION OF THE DRAWINGS

FIG. 1 is a block diagram showing a structure of a wearable device according to an embodiment of the present disclosure;

FIG. 2 is a schematic diagram of a smart watch according to an embodiment of the present disclosure;

FIG. 3 is a side cross-sectional view showing the smart watch according to the embodiment of the present disclosure in a normal state;

FIG. 4 is a side cross-sectional view showing the smart watch according to the embodiment of the present disclosure in a state where a power key is pressed; and

FIG. 5 is a side cross-sectional view showing the smart watch according to the embodiment of the present disclosure in a state where a confirmation key is pressed.

### DETAILED DESCRIPTION OF THE EMBODIMENTS

The disclosure will be described in detail below with reference to the drawings in conjunction with the embodiments. It should be noted that the embodiments in the present disclosure and the features in the embodiments may be combined with each other without conflict.

It should be noted that the terms “first”, “second”, and the like in the specification and claims of the present disclosure are configured to distinguish similar objects, and are not necessarily configured to describe a particular order or successive order.

In the related art, the keys of the wearable devices are provided in two arrangements. In one arrangement, the keys are arranged on the front surface of the device. The arrangement on the front surface of the watch may occupy a large display area of device, resulting in the unattractive appearance. In some examples, adjustment keys may be added on the side surface. In the other arrangement, the keys are placed on the side surface of the device. The keys are arranged on the side surface of the device in two ways. In one way, a knob-type key (similar to the key used in a mechanical watch) can be employed, which is pressed for a long period of time to turn on the device and is rotated to adjust the volume. However, the most serious shortage of this arrangement is small keys such that the operation is very inconvenient. In the other way, the power key is arranged on one side and the two adjustment keys are arranged on the other side.

The above arrangements of the keys will lead to the following problems: 1) the user experience is inferior, and in particular, the key arranged on the front surface of the device occupies the display area of the device, thereby affecting the display of the device and resulting in an unattractive watch; for the key arranged on the front or side surface of the device, it is very inconvenient to operate when a user, especially man having large hands, encounters a small key in use and; 2) the productivity is inferior, and in particular, for the above arrangements of the key in the production, the small power and adjustment keys are inferior in productivity, not easy to assemble, and inconvenient to operate.

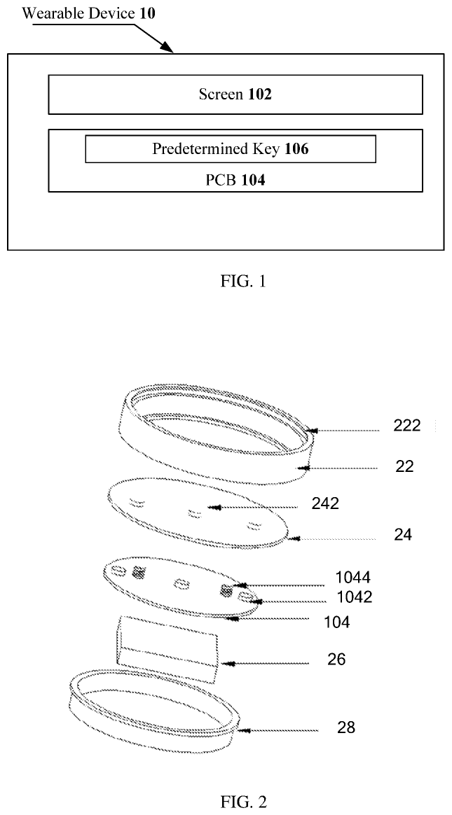

Examples of the wearable device according to the first embodiment of the present disclosure can be applied to a smart watch, a smart bracelet, or the like. FIG. 1 is a block diagram showing the structure of the wearable device according to an embodiment of the present disclosure. As shown in FIG. 1, the wearable device 10 includes a screen 102, a PCB 104, and a predetermined key 106 for executing a predetermined function (optionally, the predetermined key 106 may include one or more of a power key and an adjustment key, wherein the adjustment key may be configured to adjust volume, time, played songs, etc. The number and functions of predetermined keys may be defined as needed). The screen 102 is provided right above the PCB 104, and the predetermined key 106 is disposed on the PCB 104. The screen 102 is configured to receive external pressure of the wearable device 10, and the pressure is applied to the predetermined key 106 to enable the predetermined key 106 to perform the predetermined function.

With the above technical solution of the embodiment of the present disclosure, the predetermined key for executing the predetermined function is disposed on the PCB board, and the screen is configured to receive the external pressure to press the predetermined key. Since the predetermined key is disposed inside the wearable device, the problems that the arrangements of the keys of the existing wearable device affect the device display and the operability is inferior in the related art can be solved, thereby improving the user experience.

Optionally, in the case where at least two predetermined keys 106 are provided, the distance between the two predetermined keys may be set to be larger than a predetermined distance.

With the above technical solution of the embodiment of the present disclosure, when one of the predetermined keys is operated, other predetermined keys cannot be pressed. Therefore, excessively fine operations on the keys can be avoided to ensure the convenience of the operation of the wearable device.

Optionally, an identification point may be provided on the screen 102 at a position corresponding to the position of the predetermined key 106 for identifying the relative position of the predetermined key on the screen, such that the user can conveniently confirm the relative position of the predetermined key 106 directly from the screen 102. The identification point can be provided in various ways. For example, the identification point can include certain pixel points corresponding to the predetermined keys 106 on the screen 102 having different brightness or color from surrounding pixel points. Such a different setting in brightness or color may be kept throughout the display of the wearable device 10, or only in a state where the wearable device 10 is turned off or locked. Further, in the case where at least two predetermined keys 106 are provided, the positions on the screen 102 corresponding to the predetermined keys may be set to have the same or different attribute (number of pixels, brightness, color, etc.) with respect to the identification points as needed.

With the above technical solution of the embodiment of the present disclosure, the identification point may be provided at the position corresponding to the position of the predetermined key for identifying the relative position of the predetermined key on the screen, such that the operation of the predetermined key can be conveniently performed to improve the user experience.

Optionally, a protruding member may be disposed directly below the screen 102 at a position corresponding to the predetermined key 106, thereby increasing an easiness of pressing the predetermined key 106 against the screen 102 by the protruding member. For example, a pressure generated by bending the screen 102 may be applied to the protruding member, and a contact area of the protruding member with the predetermined key 106 can be larger than the contact area with the predetermined key 106 when the screen 102 is bent, or a movement distance of the screen 102 pressed against the predetermined key 106 can be reduced, thereby easily pressing the predetermined key 106.

With the above technical solution of the embodiment of the present disclosure, the protruding component is disposed directly below the screen at the position corresponding to the predetermined key, thereby increasing the ease of pressing the predetermined key against the screen, improving the convenience of the user operation, and reducing the loss of the screen.

Optionally, a resilient support member (such as a spring or elastic plastic or the like) may be disposed between the PCB 104 and the screen 102 to prevent an essential components (such as, a connector, etc.) on the PCB 104 from being damaged. In the meanwhile, it is possible to ensure that the screen 102 can be bounced back to a predetermined position (e.g., an initial position) when the predetermined key 106 is pressed. The specific location of the resilient support member can be determined by the placement of the essential components on the PCB 104 or the position of the predetermined key 106. For example, in the case where at least two predetermined key 106 are provided, the position of the resilient support member may be located between at least two predetermined keys. The number of resilient support members can be determined by the number of essential components on the PCB 104 or the number of predetermined keys 106.

With the above technical solution of the embodiment of the present disclosure, the resilient support member is disposed between the PCB and the screen, thereby reducing the influence of the screen being pressed on the components in the wearable device, ensuring the safe movement and rebound of the screen, and improving the reliability of the user operation.

Optionally, the wearable device 10 may further include an upper casing and a lower casing, wherein the upper casing is fixedly mounted with the screen 102, the PCB 104 is disposed between the screen 102 and the lower casing, and the upper casing and the screen are coupled in a various ways, for example, by snap-on connection.

With the above technical solution of the embodiment of the present disclosure, the snap-on connection between the upper casing and the lower casing of the wearable device can facilitate the user's disassembly operation when internal components (such as predetermined keys, PCB boards, etc.) of the wearable device need to be processed.

Optionally, the screen 102 can be a Touch Panel and Liquid Crystal Display (referred to as TP+LCD).

Optionally, the wearable device 10 can be a smart watch or a smart bracelet.

Based on the above embodiments and preferred embodiments, in order to explain the entire structure of the wearable device, in the present embodiment, there is provided a smart watch. FIG. 2 is a schematic diagram of a smart watch according to an embodiment of the present disclosure. As shown in FIG. 2, the smart watch includes an upper casing 22, a TP+LCD 24 (similar to the screen 102 as described above), a PCB 104, a battery 26, and a lower casing 28, wherein a key 1042 (similar to the predetermined key 106 as described above) is disposed on the PCB 104. The TP+LCD 24 can be replaced with other structural components having the same function.

In the smart watch, the TP+LCD 24 is fixedly assembled together, and the PCB 104, the keys 1042 on the PCB 104 (the keys are formed as DOME, for example, in any other form that can be realized) and the lower casing 26 are connected together. The keys 1042 include a power key, an up confirmation key, and a down confirmation key. The power key is disposed in the middle of the PCB 104, and the two confirmation keys are disposed on both sides of the power key, respectively. A protruding member 242 (for example, in the form of a key) is disposed on a bottom of the LCD panel at a position corresponding to the key 1042. When turning on the device, the middle part of the TP+LCD 24 is pressed for a long period of time, such that the protruding member 242 on the bottom of the LCD can press the power key on the PCB 104 (when the keys are designed, it is necessary to ensure that two confirmation cannot be pressed when the power key is pressed) for a few seconds (which can be set according to the actual situation and which can be any seconds acceptable to the user) to normally turn on the device. After the hand is removed, the upper casing 22 is bounced back to its initial position, and the power key is released. If the volume needs to be increased, the position on the TP+LCD 24 corresponding to the up confirmation key is pressed for a long period of time. Similar operations can be applied to decrease the volume.

The upper casing 22, the TP+LCD 24, the PCB 104, the battery 26, and the lower casing 26 of the smart watch will be described hereinafter.

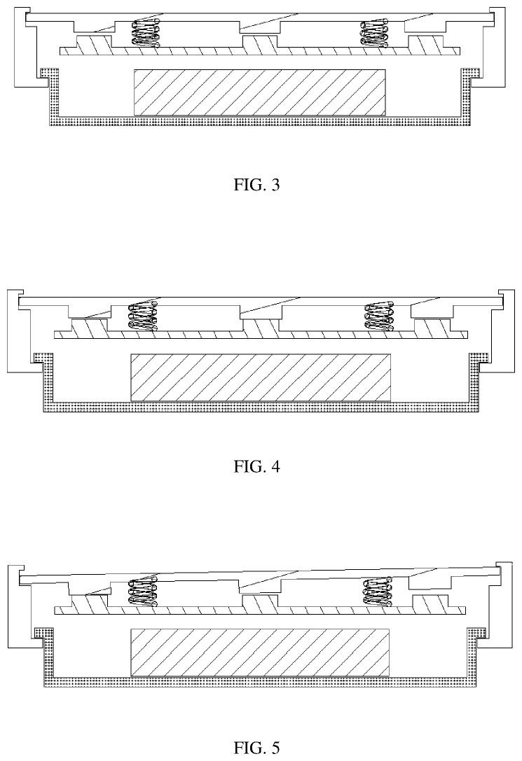

A buckle 222 is disposed on the upper casing 22. The upper casing 22 and the TP+LCD 24 are coupled by the buckle 222. The buckle 222 can protect the TP+LCD 24 to avoid the TP+LCD 24 from being over-extended or unable to be restored after the pressure, as shown in FIG. 3.

The TP+LCD 24 can be mainly used for screen displaying, receiving user input and interacting with the PCB 104. The protruding member 242 is provided on bottom of the TP+LCD 24. The protruding member 242 may be of any shape and the number thereof may be arbitrary. The shape depends on the specific design, and the number depends on the number of the keys 1042 on the PCB 104. The protruding member 242 may be in contact with or may be separated from the key 1042 on the PCB 104 as long as the user can perform effective touch for key operations.

The PCB 104 is configured to implement the main functions of the smart watch, on which keys 1042 for use with the protruding member 242 and support column 1044 (similar to the resilient support member) for implementing the supporting function are provided. The support column 1044 is configured to ensure that the upper casing 22 can be restored to the initial position after pressed. The support column 1044 can be any member that can implement the functions of supporting and rebounding to the initial position, such as a spring. The PCB 104 is coupled to the lower casing 26, and may be fixedly mounted to the lower casing 26 or may be placed in a cavity formed by the upper casing 22 and the lower casing 26.

The battery 26 is mainly configured to provide the smart watch with the necessary power for the system operation.

The lower casing 26 is coupled to the PCB 104 and the battery 26 to serve as a support, and is used in conjunction with the upper casing 22 to ensure that the upper casing 22 can work effectively and return to the initial position in time when the key is pressed.

The specific processing flow of the keys of the smart watch will be described in detail hereinafter.

FIG. 3 is a side cross-sectional view showing a smart watch according to an embodiment of the present disclosure in a normal state. As shown in FIG. 3, the connection between the upper casing 22 and the lower casing 26 is illustrated from the schematic cross-sectional view, in which the pressure on the upper casing 22 to move the upper casing 22 up and down can trigger the power key and two confirmation keys. It can also be seen from the schematic cross-sectional view that the buckle 222 surrounding a dial and the support columns 1044 are provided, and the keys 1042 and the buckle 222 cooperate with each other to ensure that the dial can be rebounded from the pressed state after the hand is removed while not being rebounded excessively. The support columns 1044 in place can avoid pressing the essential components on the PCB and further avoid damaging the pressed components such as the connector. The specific position of the support column 1044 is determined by the placement of the essential components on the PCB 104 or by the position of the key 1042. The power key and the confirmation key can be located anywhere on the PCB 104, and the power key is not limited to the middle of the PCB 104 while the two confirmation keys are not limited to the two sides of the power-on key, respectively.

FIG. 4 is a side cross-sectional view showing the smart watch according to the embodiment of the present disclosure in a state where the power key is pressed. As shown in FIG. 4, in the state where the power key is pressed, according to a predetermined pressing time of the power key, when the predetermined pressing time is reached, the function of turning on or off can be realized. At this point, the confirmation key is not touched.

FIG. 5 is a side cross-sectional view showing the smart watch according to the embodiment of the present disclosure in a state where a confirmation key is pressed. As shown in FIG. 5, in the state where the confirmation key is pressed, according to a predetermined pressing time of the confirmation key, when the predetermined pressing time is reached, the function of the confirmation key can be realized with the power key not being touched.

Through the above technical solution of the present disclosure, the predetermined keys such as the power key and the confirmation key are arranged inside a wearable device such as a smart watch, and the appearance of the entire device is nice and concise. The user can conveniently operate in actual use regardless of the size of the palm and the environment. In any case, the user's target operation can be realized quickly and conveniently, and the user experience is improved. In the production, there is no traditional constant-moving piecemeal structural parts and the integrated structure is mainly provided, thereby facilitating the transportation and assembly, and improving the production efficiency.

Obviously, it will be appreciated by those skilled in the art that the various modules or steps of the present disclosure described above can be implemented by a general-purpose computing device, which can be centralized on a single computing device or distributed across a network of multiple computing devices. Alternatively, they may be implemented by program code executable by the computing device such that they may be stored in the storage device for execution by the computing device. In some cases, the steps shown or described can be performed in a different order herein or fabricated separately into individual integrated circuit modules, or a plurality of modules or steps thereof are fabricated as a single integrated circuit module. Thus, the disclosure is not limited to any specific combination of hardware and software.

The above are only the embodiments of the present disclosure, and are not intended to limit the present disclosure. Various modifications and changes can be made to the present disclosure. Any modifications, equivalent substitutions, improvements made within the spirit and scope of the present disclosure are intended to be included within the scope of the present disclosure.

### INDUSTRIAL APPLICABILITY

Embodiments of the present disclosure provide a wearable device including a screen and a printed circuit board PCB, wherein the PCB is provided with a predetermined key for performing predetermined functions, and the screen is disposed directly above the PCB board. The screen is configured to apply a received external pressure of the wearable device to the predetermined key, so that the predetermined key performs the predetermined functions. With the present disclosure, the problems that the arrangements of the keys of the wearable devices affect the device display and the operability is inferior in the related art can be solved, thereby improving the user experience.

1. A wearable device, comprising:
a screen; and
a printed circuit board PCB provided with a predetermined key for executing a predetermined function, the screen being provided directly above the PCB, wherein
the screen is configured to receive external pressure on the wearable device, and the pressure is applied to the predetermined key to enable the predetermined key to perform the predetermined function.

2. The wearable device according to claim 1, wherein
in a case where at least two predetermined keys are provided, a distance between the at least two predetermined keys is greater than a predetermined distance.

3. The wearable device according to claim 1, wherein
an identification point is provided on the screen at a position corresponding to the predetermined key, and is configured to identify a relative position of the predetermined key on the screen.

4. The wearable device according to claim 1, further comprising: a protruding member disposed directly below the screen at a position corresponding to the predetermined key, and configured to increase an easiness of pressing the predetermined key against the screen.

5. The wearable device according to claim 1, further comprising: a resilient support member provided between the PCB and the screen.

6. The wearable device according to claim 5, wherein the resilient support member is a spring or an elastic plastic.

7. The wearable device according to claim 6, wherein
in a case where at least two predetermined keys are provided, the resilient support member is disposed between the at least two predetermined keys.

8. The wearable device according to claim 1, further comprising: an upper casing and a lower casing, wherein the upper casing is fixedly mounted to the screen, the PCB is disposed between the screen and the lower casing, and the upper casing and the screen are coupled by snap-on connection.

9. The wearable device according to claim 1, wherein the predetermined key is a power key and/or an adjustment key.

10. The wearable device according to claim 9, wherein the wearable device is a smart watch or a smart bracelet.

11. The wearable device according to claim 3, wherein the identification point includes pixel points corresponding to the predetermined key on the screen having different brightness or color from surrounding pixel points.

12. The wearable device according to claim 8, wherein a buckle is disposed on the upper casing and the upper casing and the screen are coupled through the buckle.

13. The wearable device according to claim 12, wherein the buckle is in a round shape.
